(19) United States
(12) Patent Application Publication
(10) Pub. No.: US 2026/0281259 A1
(43) Pub. Date: Sep. 17, 2026

(54) IMAGE FORMING APPARATUS

(71) Applicant: KYOCERA Document Solutions Inc., Osaka-shi, Osaka (JP)

(72) Inventor: Kotaro KUBOTA, Osaka (JP)

(21) Appl. No.: 18/850,523

(22) PCT Filed: Mar. 22, 2023
(86) PCT No.: PCT/JP2023/011169

§ 371 Date: Sep. 24, 2024

(30) Foreign Application Priority Data
Mar. 28, 2022 (JP) 2022-051478

(51) Int. Cl. H04N 1/00; G06F 3/04817; G06F 3/0482; G09G 3/3208

(52) U.S. Cl. CPC H04N 1/00413; G06F 3/04817; G06F 3/0482; G09G 3/3208; G09G 2330/022; G09G 2340/08

(57) ABSTRACT

The present invention aims at avoiding a situation where convenience of a user is impaired while securing an effect of power-saving control. When a plurality of target devices are in a normal state, a control portion (51) causes an organic electro-luminescence display panel (3b) to display a first menu screen that includes a first background image in a color other than black and a plurality of first icon images provided on the first background image (S102). Further, when the plurality of target devices are shifted from the normal state to a pause state, the control portion (51) causes the organic electro-luminescence display panel (3b) to display a second menu screen that includes a second background image in black and a plurality of second icon images provided on the second background image (S110).

### TECHNICAL FIELD

The present invention relates to an image forming apparatus including an organic electro-luminescence display panel.

### BACKGROUND

An image forming apparatus such as a printer, a copying machine, a facsimile apparatus, or a multifunction peripheral executes power-saving control. In the power-saving control, a control portion executes pause processing when a pause condition is satisfied and executes return processing when a return event occurs.

In the pause processing, the control portion causes a plurality of target devices including an image forming portion, a display panel, and the like to pause. In addition, in the return processing, the control portion activates the plurality of target devices.

Further, the image forming apparatus may include an operation device including an organic electro-luminescence display panel. Hereinafter, the organic electro-luminescence display panel will be referred to as an OEL (Organic Electro-Luminescence) display panel. In general, the OEL display panel consumes small power and is suited for thinning of a display device.

In addition, in the image forming apparatus, when display of the OEL display panel is stopped, the control portion controls the OEL display panel according to a status of fulfillment of a predetermined condition. For example, it is known that the control portion causes the OEL display panel to selectively display an image corresponding to a condition that has been satisfied out of a plurality of display conditions (see, for example, Patent Literature 1).

### CITATION LIST

### Patent Literature

Patent Literature 1: WO 2020/189249

### SUMMARY

### Technical Problem

Incidentally, in the pause processing, when the display of the OEL display panel is stopped, power consumption of the image forming apparatus is additionally reduced. In this case, when a predetermined return event occurs, the control portion causes the OEL display panel to display a menu screen.

For example, the return event is an operation event in which an operation with respect to a return button of the operation device is detected. In this case, a user needs to perform an operation to the return button and an instruction operation corresponding to the menu screen for instructing the image forming apparatus to carry out processing. Convenience of the user is impaired by such an increase in the number of operations.

Meanwhile, the operation event may include an event in which a person is detected by a human detecting sensor. In this case, the number of components related to the human detecting sensor in the image forming apparatus increases, and thus costs increase. In addition, when people passing by the human detecting sensor are detected, the return processing is executed ineffectually, and a power-saving effect of the image forming apparatus is impaired.

The present invention aims at providing an image forming apparatus capable of avoiding a situation where convenience of a user is impaired while securing an effect of the power-saving control.

### Solution to Problem

An image forming apparatus according to an aspect of the present invention includes an operation device and a control portion. The operation device includes an organic electro-luminescence display panel capable of displaying a color image. The control portion is capable of causing a plurality of predetermined target devices to shift from one of a normal state and a pause state where power consumption is smaller than that of the normal state to another one of the normal state and the pause state. When the plurality of target devices are in the normal state, the control portion causes the organic electro-luminescence display panel to display a first menu screen that includes a first background image in a color other than black and a plurality of first icon images provided on the first background image. When the plurality of target devices are shifted from the normal state to the pause state, the control portion further causes the organic electro-luminescence display panel to display a second menu screen that includes a second background image in black and a plurality of second icon images provided on the second background image.

### Advantageous Effects of Invention

According to the present invention, it is possible to provide an image forming apparatus capable of avoiding a situation where convenience of a user is impaired while securing an effect of power-saving control.

### BRIEF DESCRIPTION OF THE DRAWINGS

FIG. 1 is a block diagram showing a configuration of an image forming apparatus according to an embodiment.

FIG. 2 is a block diagram showing a configuration of a plurality of processing modules in a CPU of the image forming apparatus according to the embodiment.

FIG. 3 is a flowchart showing exemplary procedures of normal state control in the image forming apparatus according to the embodiment.

FIG. 4 is a flowchart showing exemplary procedures of pause state control in the image forming apparatus according to the embodiment.

FIG. 5 is a diagram showing an example of a first menu screen in the image forming apparatus according to the embodiment.

FIG. 6 is a diagram showing an example of a second menu screen in the image forming apparatus according to the embodiment.

### DETAILED DESCRIPTION

Hereinafter, an embodiment of the present invention will be described below with reference to the drawings. It is noted that the following embodiment is an example of embodying the present invention and does not limit the technical scope of the present invention.

### Configuration of Image Forming Apparatus 10

An image forming apparatus 10 according to the embodiment includes a printing device 1 which executes print processing. The print processing is processing of forming an image on a sheet 91.

In addition, the image forming apparatus 10 also includes an image reading device 2 which executes image reading processing for reading an image from a document sheet 92. For example, the image forming apparatus 10 is a copying machine, a multifunction peripheral having a copying function and a function of a facsimile communication device, or the like.

The image forming apparatus 10 is communicable with other apparatuses such as host apparatuses 9 via a network 90 such as a LAN (Local Area Network). For example, the network 90 is connected to the Internet. The host apparatus 9 is an information processing apparatus that is communicable with the image forming apparatus 10.

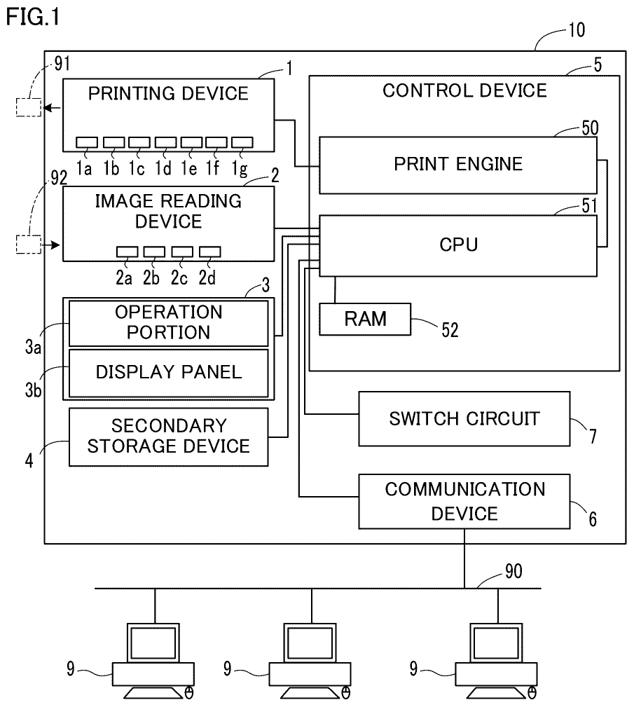

As shown in FIG. 1, the image forming apparatus 10 includes the image reading device 2, the printing device 1, an operation device 3, a secondary storage device 4, a control device 5, a communication device 6, a switch circuit 7, and the like.

The operation device 3 is a user interface device that includes an operation portion 3a and a display panel 3b. The operation portion 3a is a device which accepts user operations and includes, for example, an operation button, a touch panel, and the like. The operation button includes one or a plurality of buttons from among a return button, a cursor movement button, and a confirmation button.

The display panel 3b is capable of displaying a color image including three or more colors. In the present embodiment, the display panel 3b is the OEL display panel described above. Accordingly, the display panel 3b includes a plurality of pixel light-emitting portions corresponding to a plurality of pixels. Each of the pixel light-emitting portions includes three organic light-emitting devices that respectively emit three primary colors. The three primary colors are red, green, and blue.

In each of the pixels, a black pixel is displayed when the three organic light-emitting devices are turned off. In each of the pixels, when one or more of the three organic light-emitting devices are turned on, a pixel of a color other than black is displayed.

The communication device 6 is a communication interface device which is communicable with other apparatuses such as the host apparatuses 9 via the network 90. The control device 5 performs all of data transmission and reception with the other apparatuses via the communication device 6.

The secondary storage device 4 is a nonvolatile computer-readable storage device. The secondary storage device 4 is capable of storing programs and various types of data. For example, one of or a combination of both of a hard disk drive and an SSD (Solid State Drive) is adopted as the secondary storage device 4.

The image reading device 2 is a device which executes reading processing for reading an image of the document sheet 92. The image reading device 2 includes a light source 2a, a scanning mechanism 2b, an image sensor 2c, an AFE (Analog Front End) 2d, and the like.

The light source 2a emits light toward the document sheet 92. The scanning mechanism 2b scans the light of the light source 2a on the document sheet 92. The image sensor 2c receives reflected light from the document sheet 92 and outputs a detection signal of a light reception amount as an image signal.

The AFE (2d) converts the image signal into digital image data. In descriptions below, an image read from the document sheet 92 by the reading processing of the image reading device 2 will be referred to as a read image.

The printing device 1 is a device which executes print processing for forming an image on the sheet 91 by a predetermined system such as electrophotography or an inkjet system.

In the present embodiment, the printing device 1 is capable of executing the print processing based on data of the read image or print data received from the host apparatus 9 via the communication device 6. The print data is data expressing an image to be subjected to the print processing.

For example, when the printing device 1 is a device which executes the print processing using electrophotography, the printing device 1 includes a sheet conveying mechanism 1a, a photoconductor 1b, a charging device 1c, a laser scanning unit 1d, a developing device 1e, a transfer device 1f, a fixing device 1g, and the like.

The sheet conveying mechanism 1a conveys the sheet 91 along a predetermined path. The charging device 1c charges a surface of the photoconductor 1b. The laser scanning unit 1d writes an electrostatic latent image on the charged surface of the photoconductor 1b.

The developing device 1e develops the electrostatic latent image formed on the photoconductor 1b into a toner image. The photoconductor 1b is an image-carrying member which rotates while carrying the toner image.

The transfer device 1f transfers the toner image formed on the photoconductor 1b onto the sheet 91. The fixing device 1g heats the toner image formed on the sheet 91 to fix the toner image onto the sheet 91.

The control device 5 executes various calculations, data processing, and control of various electric devices provided in the image forming apparatus 10. The control device 5 is capable of exchanging data and control signals with the image reading device 2, the printing device 1, the operation device 3, and the communication device 6.

The control device 5 includes a print engine 50, a CPU 51, a RAM (Random Access Memory) 52, and the like. The print engine 50 controls the printing device 1 according to an instruction from the CPU 51 to thus cause the printing device 1 to execute the print processing.

The print engine 50 is realized by a processor such as an MPU (Micro Processing Unit) or a DSP (Digital Signal Processor) (not shown) or a circuit such as an ASIC (Application Specific Integrated Circuit).

The CPU 51 is a processor which executes the programs stored in the secondary storage device 4 to thus execute the various types of data processing and control. The CPU 51 is an example of a control portion.

It is noted that other processors such as the DSP may alternatively execute the data processing and control in place of the CPU 51.

The RAM 52 is a volatile storage device which primarily stores the programs to be executed by the CPU 51 and data to be output and referenced by the CPU 51 during a process of executing the programs.

The switch circuit 7 is a circuit which switches power feed lines to a plurality of predetermined target devices from one of a conduction state and a shutoff state to the other according to a switch control signal output from the CPU 51.

In the present embodiment, the plurality of target devices include the printing device 1, the image reading device 2, the secondary storage device 4, and the print engine 50.

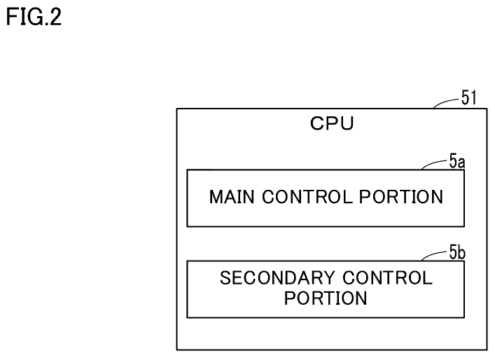

The CPU 51 executes the programs to operate as a plurality of processing modules. The plurality of processing modules include a main control portion 5a, a secondary control portion 5b, and the like (see FIG. 2).

The main control portion 5a controls the display panel 3b to cause the display panel 3b to display various types of information. In addition, the main control portion 5a determines a content of a processing request input via the operation portion 3a or the communication device 6, and executes processing corresponding to the content of the processing request.

The main control portion 5a further controls the print engine 50, the image reading device 2, and the like.

For example, when the communication device 6 receives a print request command and print job data including the print data from the host apparatus 9, the main control portion 5a outputs a reception print instruction to the print engine 50.

Upon receiving the reception print instruction from the main control portion 5a, the print engine 50 causes the printing device 1 to execute the print processing that is based on the print data.

Further, the main control portion 5a executes pause processing when a predetermined pause condition is satisfied. The pause processing is processing of controlling the switch circuit 7 to stop power supply to the plurality of target devices.

By executing the pause processing, the plurality of target devices in the image forming apparatus 10 shift from a normal state to a pause state. The normal state is a state where power is supplied from a power supply circuit (not shown) to the plurality of target devices via the switch circuit 7.

On the other hand, the pause state is a state where the power supply to the plurality of target devices is stopped. In the pause state, power consumption is smaller than that of the normal state.

When the plurality of target devices are in the normal state, the image forming apparatus 10 is capable of executing image processing such as the print processing or the reading processing. On the other hand, when the plurality of target devices are in the pause state, the image forming apparatus 10 can receive data via the communication device 6 but cannot execute the image processing.

Furthermore, in the pause processing, the main control portion 5a shifts the CPU 51 to a sleep mode in which power consumption is smaller than that of a normal mode. For example, in the sleep mode, the CPU 51 operates at clocks of a frequency lower than that of the normal mode.

Further, the main control portion 5a executes activation processing when power is supplied to the image forming apparatus 10 by an operation to a power supply switch. By the main control portion 5a executing the activation processing, the plurality of target devices shift from the pause state to the normal state.

In either of the normal mode and the sleep mode, the CPU 51 can execute the processing of receiving data via the communication device 6 and control of the switch circuit 7.

For example, the pause condition includes a time condition that a time that has elapsed since an end of processing corresponding to the processing request reaches a preset setting time. The processing request may be received via the communication device 6. Further, the processing request may be input via the operation portion 3a.

Meanwhile, the secondary control portion 5b executes return processing when a predetermined return event occurs under a situation where the plurality of target devices are in the pause state. The return processing is processing of supplying power to the plurality of target devices.

In addition, in the return processing, the secondary control portion 5b causes the CPU 51 to shift from the sleep mode to the normal mode. By executing the return processing, the plurality of target devices shift from the pause state to the normal state.

When the print processing is requested while the plurality of target devices are in the pause state, the secondary control portion 5b first executes the return processing. Subsequently, the main control portion 5a and the print engine 50 cause the printing device 1 to execute the print processing.

For example, the return event includes a reception event and a return operation event described below.

The reception event is an event in which a processing request that requires some or all of the plurality of target devices has been received from the host apparatus 9 via the communication device 6.

The return operation event is an event in which a predetermined return operation has been made to the operation portion 3a. In the present embodiment, the return operation is an event in which an operation to the return button of the operation portion 3a has been detected.

The pause processing by the main control portion 5a and the return processing by the secondary control portion 5b are each an example of the power-saving control. The main control portion 5a and the secondary control portion 5b are capable of causing the plurality of target devices to shift from one of the normal state and the pause state where power consumption is smaller than that of the normal state to the other one of the normal state and the pause state.

Incidentally, when display of the display panel 3b is stopped in the pause processing, power consumption of the image forming apparatus 10 is additionally reduced. In this case, when the return event occurs, the main control portion 5a causes the display panel 3b to display a menu screen.

For example, the return event is the reception event or the return operation event. The return operation event is an example of an operation event of detecting an operation made to the operation device 3. In this case, the user needs to perform an operation to the return button and an instruction operation corresponding to the menu screen for instructing the image forming apparatus 10 to execute processing. Convenience of the user is impaired by such an increase in the number of operations.

Meanwhile, the return event may include an event in which a person is detected by a human detecting sensor. In this case, the number of components related to the human detecting sensor in the image forming apparatus 10 increases, and thus costs increase. In addition, when people passing by the human detecting sensor are detected, the return processing is executed ineffectually, and a power-saving effect of the image forming apparatus 10 is impaired.

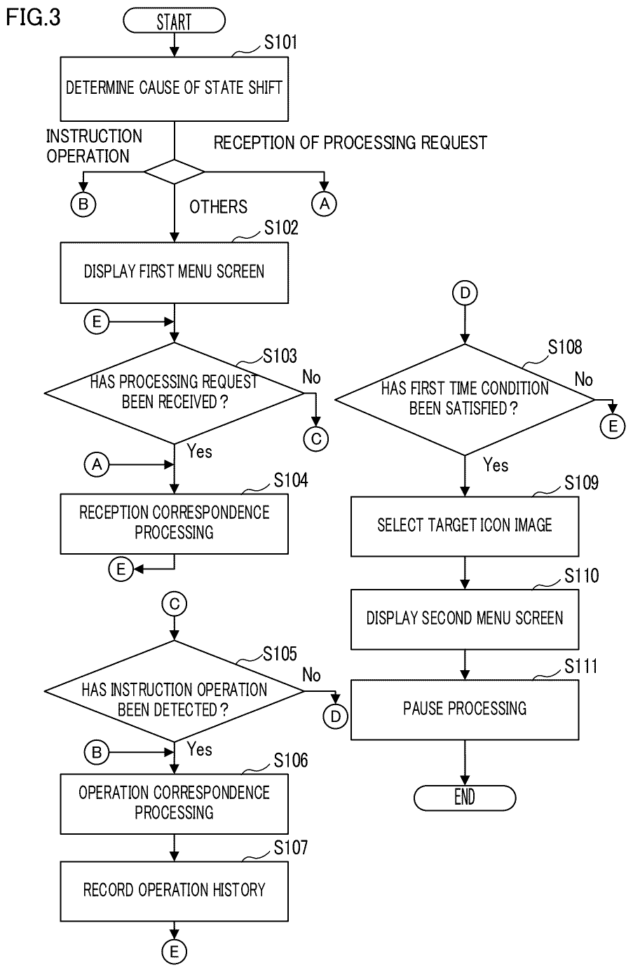

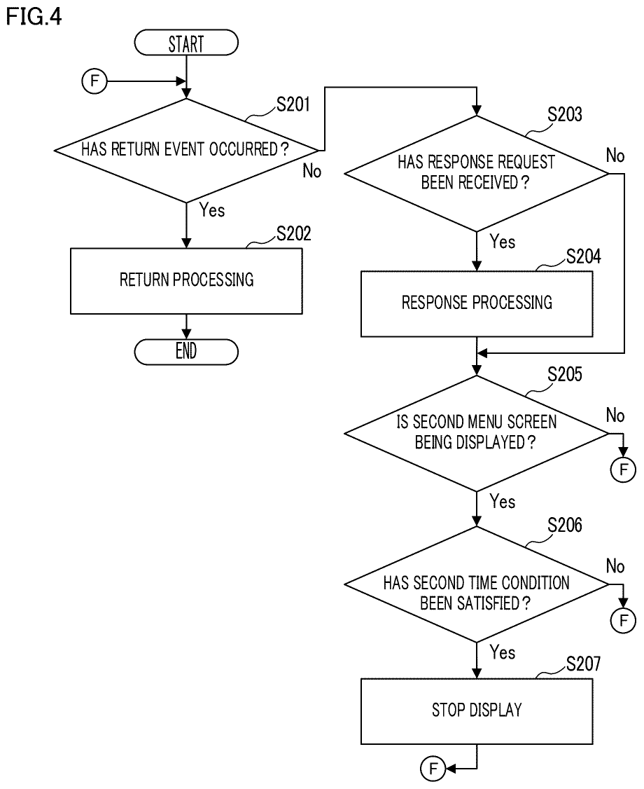

In the present embodiment, the main control portion 5a executes normal state control to be described later (see FIG. 3). Further, the secondary control portion 5b executes pause state control to be described later (see FIG. 4). Thus, it is possible to avoid a situation where the convenience of the user is impaired while securing the effect of the power-saving control.

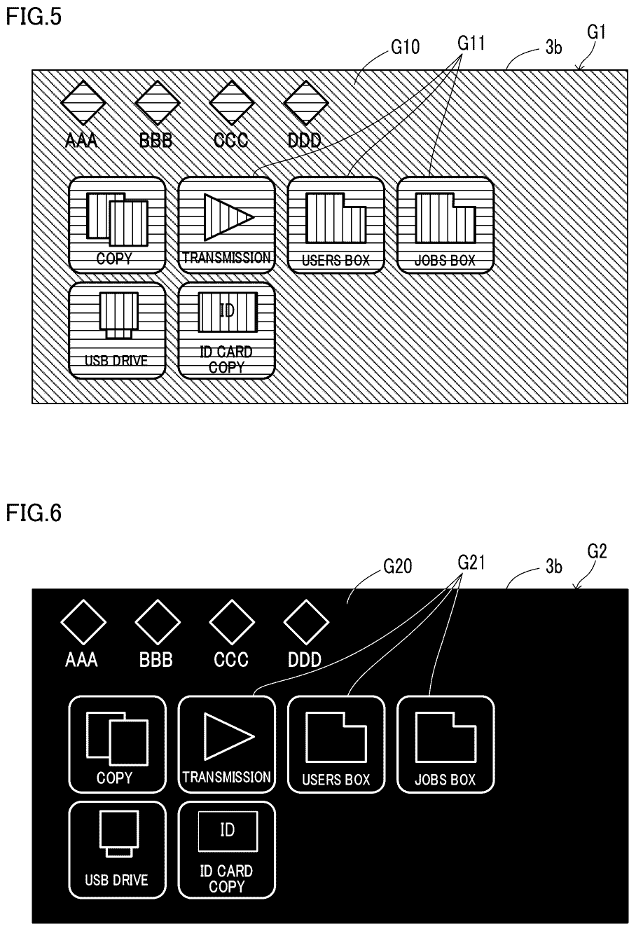

The main control portion 5a is capable of causing the display panel 3b to display a first menu screen G1 and a second menu screen G2 (see FIG. 5 and FIG. 6). The first menu screen G1 and the second menu screen G2 are each a screen that accepts an operation of designating the processing to be executed by the image forming apparatus 10.

The first menu screen G1 includes a first background image G10 and a plurality of first icon images G11 provided on the first background image G10 (see FIG. 5). The first background image G10 is an image in a color other than black. For convenience, a hatched region in FIG. 5 indicates a region of the color other than black.

In each of the plurality of pixels in the first background image G10, at least one of the three organic light-emitting devices is emitting light. For example, the first background image G10 is a uniform image in a chromatic color or in gray.

The plurality of first icon images G11 are each an image of an icon corresponding to the instruction operation for instructing the image forming apparatus 10 to execute processing.

For example, the instruction operation is an operation made to the touch panel of the operation portion 3a. Alternatively, the instruction operation may be operations made to the cursor movement button and the confirmation button of the operation portion 3a.

In the present embodiment, the plurality of first icon images G11 are each an image including a filled-in portion and a first outline. The filled-in portion is a portion that is filled in. The first outline is a line indicating an outline of the filled-in portion. The first outline is a line of a first specific color. The first specific color is a predetermined color.

Meanwhile, the second menu screen G2 includes a second background image G20 and a plurality of second icon images G21 provided on the second background image G20 (see FIG. 6). The second background image G20 is an image in black.

In each of the plurality of pixels in the second background image G20, all of the three organic light-emitting devices are turned off.

The plurality of second icon images G21 respectively correspond to the plurality of first icon images G11. The plurality of second icon images G21 are also each an image of an icon corresponding to the instruction operation.

In the present embodiment, the plurality of second icon images G21 are each an image configured by a second outline in a second specific color other than black (see FIG. 6). The second specific color is a predetermined color. It is noted that any of the plurality of second icon images G21 does not include the filled-in portion.

For example, each of the second icon images G21 is an image obtained by substituting pixels of a color other than the first specific color in each of the first icon images G11 by pixels of black. In this case, the second outline of each of the second icon images G21 has the same shape as the first outline of each of the corresponding first icon images G11. Thus, the plurality of second icon images G21 can be generated from data of the plurality of first icon images G11.

Specifically, the first specific color may be black. In this case, each of the second icon images G21 is an image obtained by substituting the pixels of the color other than black in each of the first icon images G11 by the pixels of black, and further substituting the pixels of black in each of the first icon images G11 by pixels of the second specific color (see FIG. 5 and FIG. 6).

For example, the second specific color is white. Alternatively, the second specific color may be one of emission colors of the three organic light-emitting devices. It is noted that the second specific color in this case is an alternative color to black.

Further, the first specific color may be the same as the second specific color. In this case, each of the second icon images G21 is an image obtained by substituting pixels of a color other than the first specific color in each of the first icon images G11 by the pixels of black. For example, the first specific color and the second specific color may both be white.

When the display panel 3b is the OEL display panel, the three organic light-emitting devices are turned off in each of the pixels of the second background image G20 in the second menu screen G2. Accordingly, power consumption of the display panel 3b when displaying the second menu screen G2 is smaller than that of the display panel 3b when displaying the first menu screen G1.

As will be described later, when the plurality of target devices are in the normal state, the display panel 3b displays the first menu screen G1.

Moreover, when the plurality of target devices shift from the normal state to the pause state, the display panel 3b displays the second menu screen G2. Thus, when the plurality of target devices are in the pause state, the display panel 3b displays the second menu screen G2.

### Normal State Control

Hereinafter, exemplary procedures of the normal state control will be described with reference to the flowchart shown in FIG. 3.

The main control portion 5a executes the normal state control when the image forming apparatus 10 is in the normal state.

In descriptions below, S101, S102, . . . represent identification codes of a plurality of steps in the normal state control. In the normal state control, processing of Step S101 is executed first.

### Step S101

In Step S101, the main control portion 5a determines a cause of a shift of the plurality of target devices from the pause state to the normal state.

When the plurality of target devices have returned to the normal state from the pause state by the reception of the processing request, the main control portion 5a shifts the processing to Step S104.

Further, when the plurality of target devices have returned to the normal state from the pause state by the detection of the instruction operation made to the operation portion 3a, the main control portion 5a shifts the processing to Step S106. In this case, the instruction operation is an operation corresponding to any of the plurality of second icon images G21 in the second menu screen G2.

Further, when the plurality of target devices are shifted to the normal state by a cause that is neither the reception of the processing request nor the instruction operation, the main control portion 5a shifts the processing to Step S103.

For example, when the plurality of target devices are shifted from the pause state to the normal state by the activation processing, the main control portion 5a shifts the processing to Step S103.

Furthermore, also when the plurality of target devices have returned to the normal state from the pause state by detection of an operation made to the return button of the operation portion 3a, the main control portion 5a shifts the processing to Step S103.

### Step S102

In Step S102, the main control portion 5a causes the display panel 3b to display the first menu screen G1 (see FIG. 5).

After executing the processing of Step S102, the main control portion 5a shifts the processing to Step S103.

### Step S103

In Step S103, the main control portion 5a checks a status of the communication device 6, and when the processing request of the host apparatus 9 is received, the main control portion 5a shifts the processing to Step S104.

On the other hand, when the processing request of the host apparatus 9 is not received by the communication device 6, the main control portion 5a shifts the processing to Step S105.

### Step S104

In Step S104, the main control portion 5a executes reception correspondence processing. In the reception correspondence processing, the main control portion 5a executes processing corresponding to the processing request received via the communication device 6.

For example, when the processing request is a print request, the main control portion 5a causes the printing device 1 to execute the print processing via the print engine 50. In this case, the printing device 1 executes the print processing that is based on the print data received subsequent to the print request.

Further, when the processing request is a data save request, the main control portion 5a saves save-target data that is received subsequent to the processing request in the secondary storage device 4.

After executing the reception correspondence processing, the main control portion 5a shifts the processing to Step S103.

### Step S105

In Step S105, the main control portion 5a checks a state of the operation portion 3a, and when the instruction operation made to the operation portion 3a is detected, the main control portion 5a shifts the processing to Step S106.

The instruction operation that may be detected in Step S105 is an operation corresponding to any of the plurality of first icon images G11 in the first menu screen G1.

On the other hand, when the instruction operation made to the operation portion 3a is not detected, the main control portion 5a shifts the processing to Step S108.

### Step S106

In Step S106, the main control portion 5a executes operation correspondence processing. In the operation correspondence processing, the main control portion 5a executes processing corresponding to the instruction operation detected in the operation portion 3a.

For example, when the detected instruction operation is a copy operation, the main control portion 5a causes, as well as cause the image reading device 2 to execute the reading processing, the printing device 1 to execute the print processing via the print engine 50. At this time, the main control portion 5a causes the printing device 1 to execute the print processing that is based on data of the read image.

Further, when the detected instruction operation is a storage data output operation, the main control portion 5a causes the printing device 1 to execute the print processing via the print engine 50. At this time, the main control portion 5a causes the printing device 1 to execute the print processing that is based on image data stored in the secondary storage device 4.

Furthermore, when the detected instruction operation is a screen switch operation, the main control portion 5a executes processing of switching the screen to be displayed by the display panel 3b to a screen corresponding to the screen switch operation.

The main control portion 5a may sometimes cause the display panel 3b to display the first menu screen G1 according to the screen switch operation. After executing the processing of Step S106, the main control portion 5a shifts the processing to Step S107.

### Step S107

In Step S107, the main control portion 5a executes operation history recording processing. The operation history recording processing is processing of recording operation history information that expresses a detection history of the instruction operation in the secondary storage device 4.

The main control portion 5a records, as the operation history information, information of an operation history for one or both of the first menu screen G1 and the second menu screen G2 in the secondary storage device 4. For example, the operation history information includes information on a time at which the instruction operation has been detected, for each type of the instruction operation.

After executing the processing of Step S107, the main control portion 5a shifts the processing to Step S103. It is noted that the main control portion 5a that executes the processing of Step S107 is an example of a history recording portion.

### Step S108

In Step S108, the main control portion 5a determines whether or not a first time condition is satisfied.

The first time condition is a condition that a standby time reaches a preset first setting time. The standby time is a time that has elapsed since an end of the processing corresponding to the processing request or the instruction operation.

In an initial state of the image forming apparatus 10, the first setting time is set to a predetermined time. Further, the main control portion 5a can change the first setting time according to a setting operation made to the operation portion 3a.

When determining that the first time condition is satisfied, the main control portion 5a shifts the processing to Step S109. On the other hand, when determining that the first time condition is not satisfied, the main control portion 5a shifts the processing to Step S103.

### Step S109

In Step S109, the main control portion 5a executes target icon selection processing. The target icon selection processing is processing of selecting a plurality of target icon images from a plurality of predetermined candidate icon images.

The plurality of target icon images are the plurality of second icon images G21 to be included in the second menu screen G2. The plurality of candidate icon images correspond to the plurality of first icon images G11 included in the first menu screen G1.

Specifically, in Step S109, the main control portion 5a specifies, based on the operation history information, an operation frequency for each of the plurality of first icon images G11 or the plurality of second icon images G21. In addition, the main control portion 5a selects the plurality of target icon images according to the operation frequencies.

For example, the main control portion 5a selects, as the target icon images, a predetermined number of images from the plurality of candidate icon images in a descending order of the operation frequencies.

Further, the main control portion 5a selects, as the target icon images, images having operation frequencies exceeding a reference frequency out of the plurality of candidate icon images.

It is noted that when the operation history information does not include information sufficient for specifying the operation frequency, the main control portion 5a selects all of the plurality of candidate icon images as the target icon images.

After executing the processing of Step S109, the main control portion 5a shifts the processing to Step S110.

### Step S110

In Step S110, the main control portion 5a causes the display panel 3b to display the second menu screen G2 including the plurality of target icon images selected in Step S109 (see FIG. 6).

After executing the processing of Step S110, the main control portion 5a shifts the processing to Step S111.

### Step S111

In Step S111, the main control portion 5a executes the pause processing. By executing the pause processing, power supply to the plurality of target devices is stopped, and the CPU 51 shifts from the normal mode to the sleep mode. It is noted that the plurality of target devices do not include the operation portion 3a and the display panel 3b.

By executing Step S110 and Step S111, the plurality of target devices shift from the normal state to the pause state while the second menu screen G2 is displayed on the display panel 3b.

It is noted that after the plurality of target devices are shifted from the normal state to the pause state, the secondary control portion 5b may cause the display panel 3b to display the second menu screen G2.

After executing the processing of Step S111, the main control portion 5a ends the normal state control. Thus, the secondary control portion 5b executes the pause state control.

### Pause State Control

Next, exemplary procedures of the pause state control will be described with reference to the flowchart shown in FIG. 4.

The secondary control portion 5b executes the pause state control when the plurality of target devices are in the pause state. In other words, the pause state control is executed under a situation where the power supply to the plurality of target devices is stopped.

In descriptions below, S201, S202, . . . represent identification codes of a plurality of steps in the pause state control. In the pause state control, processing of Step S201 is executed first.

### Step S201

In Step S201, the secondary control portion 5b executes processing of checking whether or not the return event has occurred. For example, the return event is the reception event, the return operation event, or an instruction operation event.

The instruction operation event is an event in which an operation corresponding to any of the plurality of second icon images G21 in the second menu screen G2 has been detected in the operation portion 3a.

When the return event occurs, the secondary control portion 5b shifts the processing to Step S202. On the other hand, when the return event has not occurred, the secondary control portion 5b shifts the processing to Step S203.

### Step S202

In Step S202, the secondary control portion 5b executes the return processing. Thus, the plurality of target devices return to the normal state from the pause state.

After executing the processing of Step S202, the secondary control portion 5b ends the pause state control.

### Step S203

In Step S203, the secondary control portion 5b checks the state of the communication device 6, and when a response request is received via the communication device 6, the secondary control portion 5b shifts the processing to Step S204.

The response request is a request for response processing. The response processing is processing of responding what kind of a state the image forming apparatus 10 is in. The response request is an example of a request for processing that does not require the plurality of target devices.

When the response request is not received via the communication device 6, the secondary control portion 5b shifts the processing to Step S205.

### Step S204

In Step S204, the secondary control portion 5b executes the response processing corresponding to the response request. In the response processing, the secondary control portion 5b transmits information expressing the state of the image forming apparatus 10 to a transmission source of the response request.

After executing the processing of Step S204, the secondary control portion 5b shifts the processing to Step S205.

### Step S205

In Step S205, the secondary control portion 5b checks the state of the display panel 3b.

When the second menu screen G2 is displayed on the display panel 3b, the secondary control portion 5b shifts the processing to Step S206. On the other hand, when the second menu screen G2 is not displayed on the display panel 3b, the secondary control portion 5b shifts the processing to Step S201.

In the present embodiment, a state where the second menu screen G2 is not displayed on the display panel 3b under the situation where the plurality of target devices are in the pause state is a state where the display panel 3b is in a non-display state. The non-display state is a state where nothing is displayed on the display panel 3b, that is, a state where all of the pixels of the display panel 3b are black.

### Step S206

In Step S206, the secondary control portion 5b determines whether or not a second time condition is satisfied. The second time condition is a condition that the standby time reaches a second setting time. The second setting time is set to be longer than the first setting time.

When the second time condition is satisfied, the main control portion 5a shifts the processing to Step S207. On the other hand, when the second time condition is not satisfied, the main control portion 5a shifts the processing to Step S201.

### Step S207

In Step S207, the secondary control portion 5b causes the display panel 3b to stop displaying images. Thus, the display panel 3b is put to the non-display state. For example, the secondary control portion 5b controls the switch circuit 7 to stop the power supply to the display panel 3b.

After executing the processing of Step S207, the secondary control portion 5b shifts the processing to Step S201.

As described heretofore, the CPU 51 causes the display panel 3b to display the first menu screen G1 when the plurality of target devices are in the normal state (see Step S102 in FIG. 3).

In addition, when causing the plurality of target devices to shift from the normal state to the pause state, the CPU 51 causes the display panel 3b to display the second menu screen G2 including the black background (see Step S110 in FIG. 3).

Accordingly, at least for a certain period after the plurality of target devices have shifted from the normal state to the pause state, the instruction operation corresponding to the second menu screen G2 is accepted by the image forming apparatus 10.

By adopting the image forming apparatus 10, an effect of the power-saving control is secured, and a situation where convenience of the user is impaired is avoided.

In addition, when the second time condition is satisfied under the situation where the second menu screen G2 is displayed on the display panel 3b, the CPU 51 causes the display panel 3b to stop the display (see Step S205 to Step S207 in FIG. 4). Thus, power consumption of the display panel 3b is additionally reduced.

It is noted that the second time condition is an example of a predetermined non-display condition.

Further, the CPU 51 selects the plurality of target icon images from the plurality of candidate icon images according to the operation frequency that is specified based on the operation history information (see Step S109 in FIG. 3).

By omitting images having relatively-low operation frequencies out of the plurality of candidate icon images from the second menu screen G2, power consumption of the display panel 3b that is displaying the second menu screen G2 is additionally reduced.

### Application Example

Next, an application example of the image forming apparatus 10 will be described.

In the present application example, the main control portion 5a or the secondary control portion 5b executes second menu screen update processing every time a predetermined change condition is satisfied. The second menu screen update processing is processing of causing the display panel 3b to display the second menu screen G2 in which the display positions of the second icon images G21 are changed.

For example, the change condition includes one or both of a first change condition and a second change condition.

The first change condition is a condition that the pause processing of Step S111 has been newly executed. When the first change condition is adopted, the main control portion 5a executes the second menu screen update processing every time the pause processing is executed.

The second change condition is a condition that the same second menu screen G2 has been continuously displayed for a predetermined time. When the second change condition is adopted, the secondary control portion 5b periodically executes the second menu screen update processing when the plurality of target devices are in the pause state.

By adopting the present application example, burn-in on the display panel 3b is prevented from occurring.

1. An image forming apparatus, comprising:
an operation device including an organic electro-luminescence display panel capable of displaying a color image; and
a control portion capable of causing a plurality of predetermined target devices to shift from one of a normal state and a pause state where power consumption is smaller than that of the normal state to another one of the normal state and the pause state, wherein
when the plurality of target devices are in the normal state, the control portion causes the organic electro-luminescence display panel to display a first menu screen that includes a first background image in a color other than black and a plurality of first icon images provided on the first background image, and
when the plurality of target devices are shifted from the normal state to the pause state, the control portion further causes the organic electro-luminescence display panel to display a second menu screen that includes a second background image in black and a plurality of second icon images provided on the second background image.

2. The image forming apparatus according to claim 1, wherein
each of the plurality of first icon images includes a filled-in portion, and
each of the plurality of second icon images is configured by an outline and does not include a filled-in portion.

3. The image forming apparatus according to claim 2, wherein
each of the plurality of first icon images is an image including an outline in a predetermined specific color, and
each of the plurality of second icon images is an image obtained by substituting pixels of a color other than the specific color in each of the plurality of first icon images by pixels of black.

4. The image forming apparatus according to claim 3, wherein
each of the plurality of second icon images is an image obtained by substituting the pixels of the color other than the specific color in each of the plurality of first icon images by the pixels of black, and further substituting pixels of the specific color in each of the plurality of first icon images by pixels of an alternative color other than the specific color.

5. The image forming apparatus according to claim 1, further comprising
a history recording portion which records information on an operation history for one or both of the first menu screen and the second menu screen in a nonvolatile storage device, wherein
the control portion selects the plurality of second icon images to be included in the second menu screen from among a plurality of predetermined candidate icon images according to an operation frequency of each of the plurality of first icon images or the plurality of second icon images, the operation frequency being specified based on the information on the operation history.

6. The image forming apparatus according to claim 1, wherein
the control portion causes the organic electro-luminescence display panel to display the second menu screen in which display positions of the plurality of second icon images are changed, every time a predetermined change condition is satisfied.

7. The image forming apparatus according to claim 1, wherein
the control portion causes the organic electro-luminescence display panel to stop display when a predetermined non-display condition is satisfied under a situation where the second menu screen is displayed on the organic electro-luminescence display panel.
